(19) United States
(12) Patent Application Publication
(10) Pub. No.: US 2022/0089225 A1
(43) Pub. Date: Mar. 24, 2022

(54) Lightweight Construction Chassis

(71) Applicant: Hymer Business Development GmbH, Bad Waldsee (DE)

(72) Inventors: Ria Kaiser, Hamburg (DE); Martin Weltjen, Oldendorf (DE)

(21) Appl. No.: 16/972,965

(22) PCT Filed: Jun. 11, 2019
(86) PCT No.: PCT/EP2019/065261

§ 371 Date: Dec. 3, 2021

(30) Foreign Application Priority Data
Jun. 8, 2018 (DE) 10 2018 113 734.6

(51) Int. Cl. B62D 29/04; B62D 21/10; B62D 63/02; B62D 21/11

(52) U.S. Cl. CPC B62D 29/041; B62D 21/11; B62D 63/025; B62D 21/10

(57) ABSTRACT

A vehicle chassis for a land vehicle, particularly for a motorhome or recreational vehicle, includes a front chassis module, particularly a traction unit, and a rear chassis module. The front chassis module is connected to the rear chassis module via at least one flange in order to form the vehicle chassis. The rear chassis module includes load-bearing components made of lightweight construction material. The rear chassis module includes at least two sub-modules; a frame module and an axle pan module that are combined to form the rear chassis module such that the frame module is connected to the front chassis module and the axle pan module is connected to the frame module.

### CROSS-REFERENCE TO RELATED APPLICATIONS

This application is the United States national phase of International Application No. PCT/EP2019/065261 filed Jun. 11, 2019, and claims priority to German Patent Application No. 10 2018 113 734.6 filed Jun. 8, 2018, the disclosures of which are hereby incorporated by reference in their entirety.

### BACKGROUND OF THE INVENTION

### Field of the Invention

The invention relates to a vehicle chassis for a land vehicle, in particular for a motorhome or a leisure vehicle.

### Description of Related Art

From the prior art, for example, from EP 2 738 068 B1, road vehicle chassis which are constructed using lightweight construction materials, in particular so-called sandwich plates are known.

The disadvantage of corresponding chassis is that the static properties are often intended to be adapted over the entire path of the chassis, whereby little flexibility in the construction of structures and the required model diversity, in particular in motorhomes, is provided.

### SUMMARY OF THE INVENTION

An object of the present invention is to develop a vehicle chassis in such a manner that with particular regard to the model diversity and the flexibility of the structure, it can be produced in a simpler and more cost-effective manner.

### DESCRIPTION OF THE INVENTION

According to the invention, this object is achieved with a vehicle chassis for a land vehicle, in particular for a motorhome or a leisure vehicle, wherein the vehicle chassis comprises a front chassis module and a rear chassis module, wherein the rear chassis module comprises at least two sub-modules.

The front chassis module may in this instance be configured as a power car as a partially integrated connection or fully integrated version. The front chassis module, in particular the power car, is connected to the rear chassis module via at least one flange means in order to form the entire vehicle chassis. The rear chassis module comprises load-bearing components made of lightweight construction material, and forms at least two sub-modules with these components. One of them is configured as a frame module, another as an axle pan module and these modules can be combined in order to form the rear chassis module in such a manner that the frame module is connected to the front chassis module and the axle pan module is connected to the frame module.

As a result of the modular construction of the chassis, it is possible to adapt the individual modules to the respective requirements or the required model diversity without always having to re-plan the complete configuration of the chassis.

In a preferred embodiment, there is provision for the load-bearing components of the rear chassis module to be at least partially, but in particular completely, constructed from composite materials, in particular a laminate.

The use of composite materials, in particular in the region of load-bearing components, provides an almost unlimited variety of geometries which can be shaped with a high level of stability and a low weight. Furthermore, corresponding composite materials, in particular laminate, are suitable, as a result of fitted reinforcements, inlays or corresponding wall thicknesses, to directly receive securing elements by means of which they are bound or connected to surrounding components (for example, by means of screw connections or riveting arrangements).

In another preferred embodiment, there is provision for the frame module to comprise at least two, preferably four load-bearing frame elements, wherein the frame elements connect the front chassis module to the axle pan module.

The load-bearing frame elements which extend through the frame module provide the necessary statics for the structure which is intended to be applied, for example, of a motorhome. Furthermore, they serve to fit the respective additional module components so that the frame module can be received, to some degree suspended, between the front chassis module and the axle pan module. The load-bearing frame elements provide the necessary static properties in this instance.

In another preferred embodiment, there is provision for the axle pan module to be constructed as a self-supporting pan, in particular as a laminate pan made of a composite material.

The term “pan” is intended to be interpreted broadly in this instance so that a substantially U-shaped axle pan module is also included within the context of the invention. The construction of the axle pan module from a composite material, in particular as a laminate pan, enables flexible and direct adaptation to the required geometry. Via the geometry, on the one hand, the precondition for connection to the frame module, on the other hand, also for receiving corresponding axle elements, for example, a rigid axle, or individual wheel suspensions, is provided. In this instance, it is particularly necessary for the introduction of the forces produced by the axle into the axle pan module and the further introduction of the resulting forces into the additional components of the chassis to be carried out in a defined manner so that the connection of the axle pan module to the other components can remain standardized.

In a preferred embodiment, there is provision for the rear chassis module to have at least one additional sub-module, in particular a rear module, wherein the additional sub-module is connected to the axle pan module.

As a result of the modular construction, it is possible following the axle pan module to connect a rear module on which, for example, the construction of a so-called rear garaging unit can be carried out. In this manner, the sizing of the relevant rear garaging unit can also be flexibly selected and can be adapted to the respective requirements of the floor plan or model diversity.

Preferably, there is further provision for the axle pan module to be constructed to be free from longitudinal beams in the inner space thereof.

As a result of the construction of the axle pan module to be free from internal longitudinal beams, consequently as a result of the construction of the axle pan module as a self-supporting static element, there is available in the region of this chassis module an expanded storage space which can be used both for the functional integration of elements of the rear axle (for example, when a rigid axle is used) and for the integration of other components, such as, for example, tanks, batteries or other elements which require storage space.

In this case, it should be noted in particular that, as a result of the static construction of the axle pan module, independently of the arranged construction of the axle and the sizing thereof or the sizing of the entire chassis, it may be possible for controlled forces to be introduced into the frame module so that the frame module, in particular the connections thereof to the axle pan module, but also the connection to the front chassis module (for example, the power car), can be constructed in a standardized manner. The respective differences of different chassis constructions or axles are absorbed by the self-supporting static construction of the axle pan module and uniform forces are introduced. An individual adaptation of different module variants is prevented in this instance.

Preferably, there is provision for at least one sub-module, in particular a plurality of sub-modules, to be constructed in such a manner that standardized receiving members between the modules enable the modules to be freely connected to each other.

In this manner, the sub-modules, for example, the frame module, can be combined and extended with an additional module. The notion of the modular construction of different chassis for different models of vehicles is supported by the standardized receiving of the modules relative to each other independently of the sub-module since various models can advantageously be combined freely with each other. In this manner, different storage space concepts can also be provided by means of special modules, for example, with an increased requirement for longitudinal storage space for sports devices or stability for specific expansions.

In another embodiment, there is provision for at least one sub-module, in particular a plurality of sub-modules, to be constructed in terms of their material nature and/or geometry in such a manner that all the forces acting on the sub-module are received in a controlled manner and can be transmitted via standardized connections to adjacent sub-modules, if necessary.

Taking into account this embodiment, the modular character enables a mutually independent geometric and static planning of the sub-modules since the forces which are transmitted via the connections are standardized and can consequently be detected independently of the module combination.

On the whole, the modular construction of the rear chassis module as a result of the sub-modules thereof, which can be freely combined, enables the provision of a module system which, as a result of standardized connections and standardized applications of force, for providing extremely different chassis variants for extremely different models of vehicles without cost-intensive individual chassis having to be kept available and planned for each model.

### BRIEF DESCRIPTION OF THE DRAWINGS

The invention is explained below in greater detail with reference to a schematically illustrated embodiment, in which:

FIG. 1 is a schematic illustration of the three sub-modules of the rear chassis module which are joined to each other;

FIG. 1a is a schematic exploded view of the rear chassis module shown in FIG. 1; and

FIG. 2 is a schematic exploded view of the components of a chassis that includes the rear chassis module shown in FIGS. 1-1a and a front chassis module.

### DESCRIPTION OF THE INVENTION

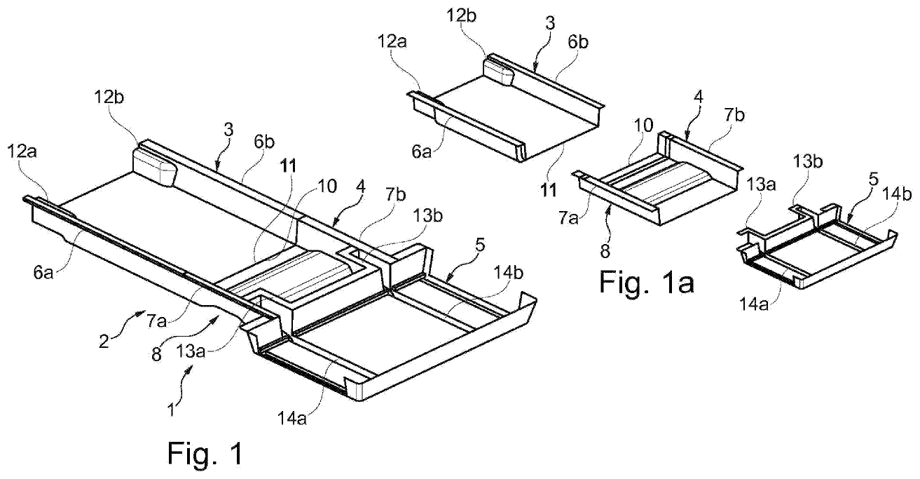

In detail, FIG. 1 is a schematic illustration of a rear chassis module 1. The rear chassis module 1 is illustrated once as an assembled illustration 2 in FIG. 1 and once with the modules thereof spatially separated from each other in FIG. 1a. The rear chassis module 1 comprises in this instance a frame module 3, an axle pan module 4 and a rear module 5.

Both the frame module 3 and the axle pan module 4 comprise side walls 6a, 6b and 7a, 7b. When viewed in the longitudinal direction, the modules frame module 3 and axle pan module 4 have U-shaped cross sections which are limited at the left side of the vehicle and at the right side of the vehicle by the side walls 6a, b and 7a, 7b.

The axle pan module 4 has in a schematically illustrated manner an axle receiving member 8 on which the axle and the wheel suspension are guided. The axle pan module 4 is connected at the front side 10 thereof to the frame module 3 at the rear side 11 thereof. As a result of the integral static construction of the axle pan module 4, a defined introduction of force to the frame module 3 is always formed at the transition 10-11, regardless of which sizing or type of axle or chassis is provided in the axle receiving member 8.

At the front end of the frame module 3, a flange means 12a, 12b is provided at each longitudinal side on the side wall 6a, 6b and is used to fit the rear chassis module 1 to a front chassis module, for example, a power car.

At the rear end of the axle pan module 4, a rear module 5, illustrated schematically in this instance, is connected via protruding receiving members 13a, 13b. The rear module has a U-shaped cross sectional profile which is rotated through 90° with respect to the longitudinal direction of the vehicle since it is generally used to form a rear garaging unit which is intended to be loaded from the side. The rear module 5 is in this instance provided with statically reinforcing longitudinal channels 14a and 14b which introduce the load of the rear module 5 in a defined manner into the receiving members 13a and 13b and consequently into the axle pan module 4.

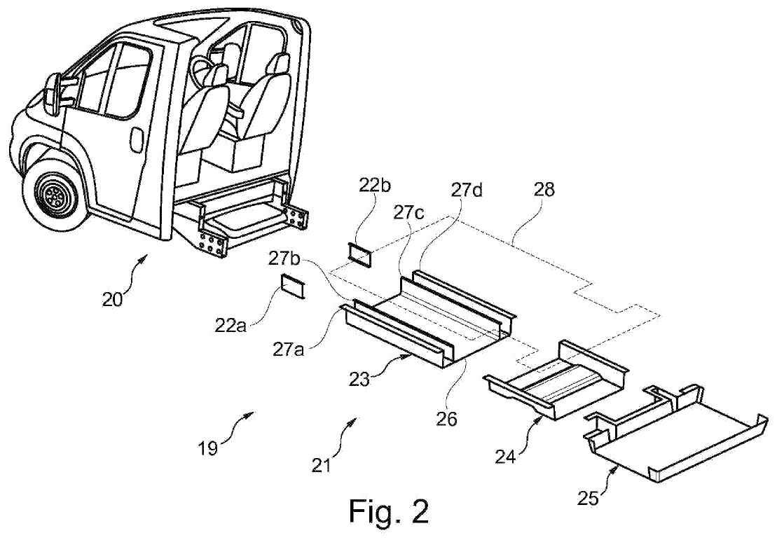

FIG. 2 is a schematic illustration of a chassis 19. A front chassis module 20, which is constructed in this instance as a power car chassis, is connected to a rear chassis module 21. Flange means 22a and 22b for fitting the rear chassis module 21 can be secured to the front chassis module 20. The rear chassis module 21 comprises, as described in FIG. 1, an axle pan module 24 and a rear module 25. The frame module 25 is in this instance illustrated in a modified illustration. In this instance, it comprises an underbody 26, on which load-bearing frame elements 27a, 27b, 27c and 27d are arranged. The underbody 26 and the load-bearing frame elements 27a to 27d form the frame module 23. In a state at least partially overlapping the frame module 23 and the axle pan module 24 and possibly the rear module 25, there is provided a walking floor 28 which covers the chassis in terms of its structure.

The frame elements 27a to 27d extend in this instance through the region of the frame module 23, but do not protrude into the inner region of the axle pan module 24. A protrusion which is statically ineffective for the axle pan module for the purposes of securing is in this instance insignificant. The axle pan module 24 itself is self-supporting and consequently statically adequately sized to transmit in a defined manner forces which occur at the axle or the chassis via the fitting to the frame elements 27a to 27d which determine the static property of the frame module 23. In this manner, the sizing and fitting to the frame elements 27a to 27d can be configured in a standardized manner, regardless of which chassis or axle construction is used.

As a result of the modular construction, the possibility is now afforded of adapting both the frame module 23 and the axle pan module 24 or the rear module 25 in terms of its sizing in accordance with the desired model of the vehicle which is intended to be constructed. For example, the frame module 23 may vary in terms of its length over a wide range and consequently have an influence on the wheelbase of the vehicle. The axle pan module 24 may, as already described above, also be formed either to receive a rigid axle or to receive a single wheel suspension or dual axles without on the whole adaptations to the frame module 23 or the rear module 25 having to be carried out.

In this manner, with a simple modular configuration of the sub-components of the rear chassis module, a large number of desired embodiments of chassis can be provided.

1. A vehicle chassis for a land vehicle wherein the vehicle chassis comprises:
a front chassis module and
a rear chassis module, wherein
the front chassis module is connected to the rear chassis module by means of at least one flange means for forming the vehicle chassis, and
wherein the rear chassis module comprises load-bearing components of lightweight construction material,
wherein the rear chassis module comprises at least two sub-modules,
wherein a frame module and an axle pan module are combined to form the rear chassis module in such a manner that the frame module is connected to the front chassis module and the axle pan module is connected to the frame module.

2. The vehicle chassis as claimed in claim 1, wherein the load-bearing components are at least partially constructed from a composite material.

3. The vehicle chassis as claimed in claim 1, wherein the frame module has at least two load-bearing frame elements, wherein the frame elements connect the front chassis module to the axle pan module.

4. The vehicle chassis as claimed in claim 1, wherein the axle pan module is constructed as a self-supporting pan.

5. The vehicle chassis as claimed in claim 1, wherein the rear chassis module comprises at least one additional sub-module wherein the additional sub-module is connected to the axle pan.

6. The vehicle chassis as claimed in claim 1, wherein the axle pan module is constructed to be free from longitudinal beams in the inner space.

7. The vehicle chassis as claimed in claim 1, wherein the axle pan module is constructed to receive and secure a rigid axle.

8. The vehicle chassis as claimed in claim 1, wherein the axle pan module is constructed to receive and secure individual wheel suspensions.

9. The vehicle chassis as claimed in claim 1, wherein at least one sub-module is/are constructed in such a manner that standardized receiving members between the modules enable the modules to be freely connected to each other.

10. The vehicle chassis as claimed in claim 1, wherein at least one sub-module is/are constructed in terms of their material nature and/or geometry in such a manner that all the forces acting on the sub-module are received in a controlled manner and can be transmitted via standardized connections to adjacent sub-modules.

11. The vehicle chassis as claimed in claim 1, wherein the front chassis module is a power car.

12. The vehicle chassis as claimed in claim 2, wherein the composite material is a laminate.

13. The vehicle chassis as claimed in claim 4, wherein the axle pan module is a laminate pan made of a composite material.

14. The vehicle chassis as claimed in claim 5, wherein the additional sub-module is a rear module.

15. The vehicle chassis as claimed in claim 2, wherein the frame module has at least two load-bearing frame elements, wherein the frame elements connect the front chassis module to the axle pan module.

16. The vehicle chassis as claimed in claim 2, wherein the axle pan module is constructed as a self-supporting pan.

17. The vehicle chassis as claimed in claim 2, wherein the rear chassis module comprises at least one additional sub-module wherein the additional sub-module is connected to the axle pan.

18. The vehicle chassis as claimed in claim 2, wherein the axle pan module is constructed to be free from longitudinal beams in the inner space.

19. The vehicle chassis as claimed in claim 2, wherein the axle pan module is constructed to receive and secure a rigid axle.

20. The vehicle chassis as claimed in claim 2, wherein the axle pan module is constructed to receive and secure individual wheel suspensions.
